(19) United States
(12) Patent Application Publication
(10) Pub. No.: US 2016/0043566 A1
(43) Pub. Date: Feb. 11, 2016

(54) POWER SOURCE DOCK

(71) Applicant: SANYO ELECTRIC CO., LTD., Osaka (JP)

(72) Inventor: KYOZO TERAO, Hyogo (JP)

(73) Assignee: Sanyo Electric Co., Ltd., Osaka (JP)

(21) Appl. No.: 14/782,584

(22) PCT Filed: Mar. 24, 2014
(86) PCT No.: PCT/JP2014/001667

§ 371 Date: Oct. 5, 2015

(30) Foreign Application Priority Data
Apr. 9, 2013 (JP) 2013-081514
Jul. 5, 2013 (JP) 2013-141490

(51) Int. Cl. H02J 5/00; H02J 7/02; H02J 7/00

(52) U.S. Cl. CPC H02J 5/005; H02J 7/0044; H02J 7/025

(57) ABSTRACT

A power source stand includes position detector 5 that detects the position of power reception coil 4 of mobile device 2 relative to power transmission coil 3 and displays the detected position of power reception coil 4. In position detector 5, an AC signal having a changing frequency is supplied from sweep oscillator 13 to detection coil 12, the position of power reception coil 4 relative to power transmission coil 3 is detected from a change in impedance of detection coil 12 with respect to the frequency of the AC signal, and the detected position of power reception coil 4 is displayed by display unit 15.

### TECHNICAL FIELD

The present invention relates to a power source dock or a power source stand that allows a mobile device such as a battery pack or a mobile phone to be set therein and supplies power to the mobile device by an electromagnetic induction action, particularly to a power source stand that displays whether a mobile device is set at an optimum position in order to allow a user to set the mobile device at the optimum position.

### BACKGROUND ART

A power source stand, in which power is transmitted from a power transmission coil to a power reception coil by an electromagnetic induction action and an incorporated battery is charged, has a characteristic of enabling non-contact power transmission. In the power source stand, it is necessary to bring the power transmission coil and the power reception coil close to each other in order to efficiently transmit the power from the power transmission coil to the power reception coil. A power source stand, which detects the position of the power reception coil incorporated in the mobile device and moves the power transmission coil to the position of the power reception coil, is developed in order to bring the power transmission coil and the power reception coil close to each other (see PTL 1).

In the power source stand disclosed in PTL 1, because the position of the power reception coil of the mobile device is detected to move the power transmission coil to the position of the power reception coil, it is necessary to provide a circuit that detects the position of the power reception coil, and a complicated driving mechanism that moves the power transmission coil to the detection position, which results in a drawback that a circuit configuration and the driving mechanism are complicated to increase production cost. The power transmission coil is fixed and a user sets the mobile device such that the mobile device comes close to the power transmission coil, which allows the drawback to be solved. For example, a setting position of the mobile device is displayed on a placing stage of the power source stand, and the user sets the mobile device in a setting position, which allows the power reception coil to come close to the power transmission coil. However, in the power source stand that transmits power to mobile devices having various outer shapes or mobile devices that incorporate power reception coils at different positions, it is difficult to always set the power reception coil and the power transmission coil at optimum positions.

The drawback can be solved by displaying whether the mobile device is located at an ideal position, for example, when the user places the mobile device on the power source stand. This is because the user can adjust the position of the mobile device while checking the display content. In this case, the setting of the mobile device in the power source stand can be detected by an increase in inductance of the power transmission coil. This is because a magnetic material such as a magnetic shield incorporated in the mobile device comes close to the power transmission coil to increase the inductance of the power transmission coil. The magnetic shield is provided in order that an AC magnetic field induced in the power reception coil is shielded to prevent heat generation of a battery. Therefore, the magnetic shield is laminated on the power reception coil and disposed on an opposite side to a surface facing the power transmission coil. Because the magnetic shield is disposed at the same position as the power reception coil, the magnetic shield comes close to the power transmission coil to increase the inductance of the power transmission coil when the power reception coil comes close to the power transmission coil. Therefore, it is detected that the power reception coil comes close to the power transmission coil, from the increase in inductance of the power transmission coil.

FIG. 1 illustrates a characteristic in which inductance of a power transmission coil changes while a power reception coil comes close to the power transmission coil. As illustrated in FIG. 1, when the power reception coil comes close to the power transmission coil, a magnetic shield comes close to the power transmission coil to increase the inductance of the power transmission coil.

### CITATION LIST

### Patent Literature

PTL 1: Unexamined Japanese Patent Publication No. 2009-247194

### SUMMARY OF THE INVENTION

As illustrated in FIG. 1, the inductance of the power transmission coil increases when the power reception coil comes close to the power transmission coil. Accordingly, the mobile device is moved to the position, where the inductance of the power transmission coil is maximized, to be able to bring the power reception coil close to the power transmission coil. However, when the mobile device is moved to the position, where the inductance of the power transmission coil is maximized, to be able to bring the power reception coil close to the power transmission coil, it is difficult to accurately bring the power reception coil close to the power transmission coil. This is attributed to the following reason. While the power reception coil is located close to the power transmission coil, the change in inductance of the power transmission coil becomes slow to hardly identify the position where the power reception coil comes closest to the power transmission coil. As illustrated in FIG. 1, the inductance of the power transmission coil is not maximized at the position where the power reception coil comes closest to the power transmission coil, but maximized at the position slightly deviated from the position where the power reception coil comes closest to the power transmission coil. Therefore, the position of the power reception coil relative to the power transmission coil cannot accurately be detected from the position where the inductance is maximized, namely, a maximum value of the inductance.

The present invention is made in order to solve the drawback. A main object of the present invention is to provide a power source stand, in which the position of the power reception coil is accurately detected and the detected position is displayed, and thereby, the user can set the mobile device at the position where the power reception coil is brought closest to the power transmission coil, thus efficiently transmitting the power.

According to the present invention, a power source stand has power transmission coil 3 fixed thereto, and includes position detector 5 that detects a relative position between power reception coil 4 of mobile device 2 set in the power source stand and incorporated power transmission coil 3 and displays the detected relative position. Position detector 5 includes: detection coil 12 that detects a position of power reception coil 4; sweep oscillator 13 that supplies an AC signal having a changing frequency to detection coil 12; detection circuit 14 that detects a change in impedance of detection coil 12 with respect to the frequency of the AC signal supplied from sweep oscillator 13 to detection coil 12; and display unit 15 that detects the position of power reception coil 4 from the change in impedance and displays the detected position. In the power source stand, position detector 5 detects the position of power reception coil 4 from the change in impedance of detection coil 12, the change being detected using detection circuit 14, and display unit 15 displays the position of power reception coil 4.

In one of the characteristics of the power source stand, the position of the power reception coil is accurately detected and the detected position is displayed, and thereby, the user sets the mobile device at the position where the power reception coil is brought closest to the power transmission coil, thus efficiently transmitting the power. Particularly, in the power source stand, a change in impedance of the detection coil is detected to detect the position of the power reception coil relative to the power transmission coil, so that the position of the power reception coil can accurately be detected to dispose the power reception coil at the position closer to the power transmission coil. Therefore, the characteristic of enabling the power to be efficiently transmitted particularly from the power transmission coil to the power reception coil can be implemented.

In the power source stand of the present invention, sweep oscillator 13 may change the frequency in a range of 750 kHz to 1.5 MHz.

In the power source stand, it is assumed that a resonant frequency identified by inductance L2 of power reception coil 4 and electrostatic capacitance C2 of a capacitor is about 1 MHz, and that sweep oscillator 13 changes the frequency in a range of 750 kHz to 1.5 MHz. At this point, there are portions in which load impedance Z becomes maximum and minimum at a frequency slightly higher than a resonant frequency of 1 MHz of power reception coil 4, and a maximum value and a minimum value can be detected based on the position of power reception coil 4 relative to power transmission coil 3.

In the power source stand of the present invention, power transmission coil 3 is also used as detection coil 12.

In the power source stand, it is not necessary to provide a dedicated detection coil, but the power transmission coil is also used as the detection coil. Therefore, there is a characteristic of enabling the position of the power reception coil relative to the power transmission coil to be more accurately detected.

In the power source stand of the present invention, detection coil 12 may be planar coil 29 that is disposed concentric with the power transmission coil 3.

In the power source stand, the position of the power reception coil relative to the power transmission coil can accurately be detected using the detection coil, and the detection coil can be provided without widening a distance between the power reception coil and the power transmission coil.

In the power source stand of the present invention, detection circuit 14 may detect the change in impedance of detection coil 12 based on a change in oscillation voltage of sweep oscillator 13.

The power source stand has the characteristic of enabling the change in impedance of the detection coil to be detected using a simple circuit configuration. This is because the change in oscillation voltage can be detected using the simple circuit configuration.

In the power source stand of the present invention, detection circuit 14 may convert the oscillation voltage of the sweep oscillator 13 into a direct current, and detects the change in impedance of detection coil 12 at a DC level.

The power source stand can detect the change in inductance of the detection coil using a simpler circuit configuration. This is because the change in inductance of the detection coil can be detected by detecting the oscillation voltage at the DC level.

In the power source stand of the present invention, detection circuit 14 may detect the position of power reception coil 4 at a value of change in impedance (ΔZ) which is a difference between a maximum value and a minimum value of the impedance of detection coil 12.

In the power source stand, the position of the power reception coil relative to the power transmission coil can more accurately be detected by more accurately detecting the change in impedance. This is because the value of the change in impedance is detected from the difference between the maximum value and the minimum value to increase the value of change in impedance (ΔZ).

In the power source stand of the present invention, detection circuit 14 may detect the position of power reception coil 4 at a minimum value of the impedance of detection coil 12.

The power source stand can detect the change in inductance of the detection coil using a simple circuit configuration. This is because the change in impedance is detected from the minimum value.

In the power source stand of the present invention, sweep oscillator 13 may include: oscillation coil 16; variable capacitance diode 18 that is connected to oscillation coil 16; and control voltage circuit 19 that supplies a control voltage changing at a constant period to variable capacitance diode 18, and sweep oscillator 13 is Hartley oscillator 13A in which the control voltage is input from control voltage circuit 19 to variable capacitance diode 18 to change an oscillation frequency at a constant period.

The power source stand has a characteristic of enabling the oscillation frequency to be changed at the constant period with the simple circuit configuration of the sweep oscillator.

In the power source stand of the present invention, clipping circuit 25 in which a pair of diodes D1 and D2 are connected in reverse parallel to each other may be connected in parallel to a part of oscillation coil 16.

In the power source stand, a fluctuation in oscillation voltage can be decreased with respect to the frequency of the sweep oscillator. Therefore, the position of the power reception coil relative to the power transmission coil can accurately be detected from the oscillation voltage of the sweep oscillator.

In the power source stand of the present invention, oscillation coil 16 includes intermediate terminal 16a, and clipping circuit 25 may be connected in parallel between intermediate terminal 16a and one end of oscillation coil 16.

The power source stand has a characteristic of enabling a fluctuation in amplitude to be decreased with respect to the frequency while outputting the sinusoidal AC signal from the sweep oscillator.

In the power source stand of the present invention, one end of oscillation coil 16 may be connected to a base of transistor 17 constituting Hartley oscillator 13A through capacitor 21, intermediate terminal 16a of oscillation coil 16 may be connected to an emitter of transistor 17, and diode clipping circuit 25 may be connected between the emitter of transistor 17 and a ground.

The power source stand has a characteristic of outputting the sine wave having the changing frequency from the Hartley oscillator that is the sweep oscillator and of preventing the fluctuation in oscillation voltage.

The power source stand of the present invention may further include: sub oscillator 31 that detects setting of mobile device 2; and sub-detection circuit 32 that detects the setting of mobile device 2 by detecting a change in inductance of power transmission coil 3 due to a change in oscillation frequency of sub oscillator 31. In the power source stand, sub-detection circuit 32 detects the setting of mobile device 2, and the position detector 5 detects the position of power reception coil 4.

In the power source stand, the setting of the mobile device is detected using the simple circuit configuration, and the detection of the position of the power reception coil relative to the power transmission coil can be started.

In the power source stand of the present invention, sub oscillator 31 may be Clapp oscillator 31A that identifies the oscillation frequency by the inductance of detection coil 12.

In the power source stand, the oscillation frequency of the Clapp oscillator is identified by the detection coil, and the inductance of the detection coil can be detected.

The power source stand of the present invention may further include: sub oscillator 31 that detects setting of mobile device 2; and sub-detection circuit 32 that detects the setting of mobile device 2 by detecting a change in oscillation voltage of sub oscillator 31. In the power source stand, sub-detection circuit 32 detects the setting of mobile device 2, and the position detector 5 detects the position of power reception coil 4.

In the power source stand, the setting of the mobile device is detected using the simple circuit configuration, and the detection of the position of the power reception coil relative to the power transmission coil can be started.

In the power source stand of the present invention, detection circuit 14 may detect the position of power reception coil 4 by a difference between a maximum value and a minimum value in a change in oscillation voltage of detection coil 12, detection coil 12 may include a plurality of coils, the plurality of coils may include: a center detection coil concentric with power transmission coil 3; and a peripheral detection coil disposed around the center detection coil, and the position where power reception coil 4 is brought close to may be displayed when the difference between the maximum value and the minimum value in the change in oscillation voltage of the center detection coil is larger than the difference between the maximum value and the minimum value in the change in oscillation voltage of the peripheral detection coil.

The power source stand of the present invention may include a plurality of peripheral detection coils. In the power source stand, the peripheral detection coils are disposed at equal intervals in an outer peripheral portion around a center of the center detection coil.

In the power source stand, the approximation of the power reception coil is recognized by the difference between the maximum value and the minimum value in the change in oscillation voltage from the center detection coil and the peripheral detection coil.

### BRIEF DESCRIPTION OF DRAWINGS

FIG. 1 is a graph illustrating a characteristic in which inductance of a power transmission coil changes while a power reception coil comes close to the power transmission coil.

FIG. 2 is a block diagram illustrating a state in which a mobile device is set in a power source stand according to an exemplary embodiment of the present invention.

FIG. 3 is a block circuit diagram of the power source stand illustrated in FIG. 2.

FIG. 4 is an enlarged sectional view illustrating an example of a dedicated detection coil.

FIG. 5 is an enlarged sectional view illustrating another example of the dedicated detection coil.

FIG. 6 is an enlarged sectional view illustrating still another example of the dedicated detection coil.

FIG. 7 is a diagram illustrating a change in oscillation voltage to an oscillation frequency of a sweep oscillator.

FIG. 8 is a circuit diagram illustrating a state in which a power reception coil is coupled to a power transmission coil.

FIG. 9 is an equivalent circuit diagram illustrating the state in which the power reception coil is coupled to the power transmission coil.

FIG. 10 is a schematic diagram illustrating another example of a display unit.

FIG. 11 is a diagram illustrating a center detection coil and a peripheral detection coil.

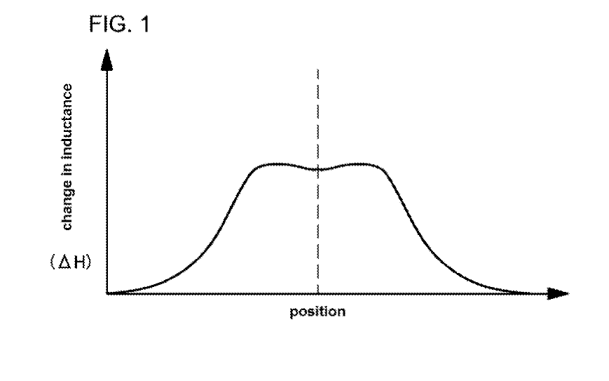

### DESCRIPTION OF EMBODIMENT

An exemplary embodiment of the present invention will be described below with reference to the drawings. Note that, a power source stand that implements a technical thought of the present invention is illustrated in the following exemplary embodiment, but the present invention is not limited to the following power source stand. In the description, for the sake of easy understanding of the claims, the reference marks corresponding to the components illustrated in the exemplary embodiment are added to the components illustrated in “CLAIMS” and “SUMMARY OF THE INVENTION”. Components illustrated in the claims are not limited to components of the exemplary embodiment.

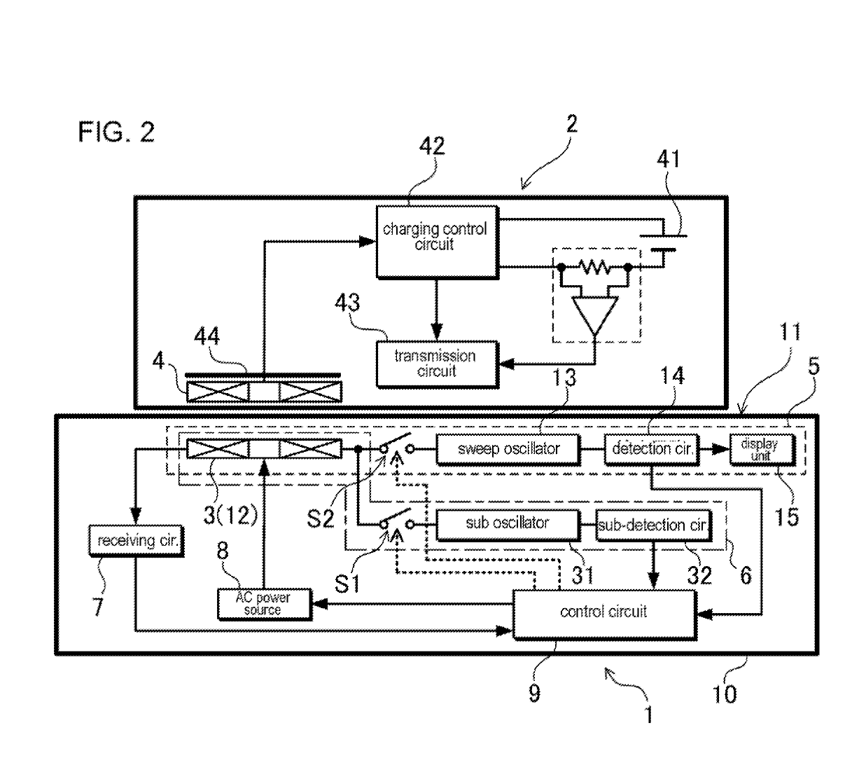

In power source stand 1 of FIG. 2, mobile device 2 is set, and power is transmitted from power transmission coil 3 to power reception coil 4 of mobile device 2 by an electromagnetic induction action to charge battery 41 incorporated in mobile device 2. In mobile device 2 set in power source stand 1, battery 41 incorporated in mobile device 2 is charged by the power transmitted from power source stand 1. Power reception coil 4 electromagnetically coupled to power transmission coil 3 of power source stand 1 is incorporated in mobile device 2 in FIG. 2, and battery 41 is charged by the power induced in power reception coil 4. Mobile device 2 includes charging control circuit 42. Charging control circuit 42 converts alternating current induced in power reception coil 4 into direct current to charge battery 41, and detects full charging of battery 41. For example, mobile device 2 is a battery pack including a rechargeable battery, a mobile phone, a portable audio device, and a portable charger including a battery charging a mobile device. The power transmitted from the power source stand to the mobile device is not necessarily limited for use in charging the battery, but may be used as, for example, power used to operate the mobile device or power supplied to the device connected to the mobile device.

In power source stand 1, upper plate 11 on which mobile device 2 is placed is provided on a top surface of case 10, and power transmission coil 3 is disposed inside upper plate 11. Power transmission coil 3 is connected to AC power source 8, and transmits AC power supplied from AC power source 8 to power reception coil 4 by the electromagnetic induction action. AC power source 8 is controlled by control circuit 9. Control circuit 9 detects a detection signal transmitted from transmission circuit 43 of mobile device 2 through power reception coil 4 and power transmission coil 3 using receiving circuit 7, controls AC power source 8 using the detected detection signal, and transmits the power to mobile device 2 while controlling the power supplied to power transmission coil 3.

In power source stand 1, power transmission coil 3 is fixed to an inner surface of upper plate 11. Power transmission coil 3 is a planar coil that is spirally wound in a plane parallel to upper plate 11, and emits an AC magnetic flux to a portion above upper plate 11. Power transmission coil 3 emits the AC magnetic flux orthogonal to upper plate 11 to the portion above upper plate 11. Power transmission coil 3 is supplied with the AC power from AC power source 8, and emits the AC magnetic flux to the portion above upper plate 11. An outer diameter of power transmission coil 3 is substantially equal to that of power reception coil 4, and power transmission coil 3 efficiently transmits the power to power reception coil 4.

Power source stand 1 includes position detector 5 that detects a position of power reception coil 4 of mobile device 2 set in the power source stand such that a user can set mobile device 2 at an optimum position, namely, such that the user can set power reception coil 4 of mobile device 2 at the position where power reception coil 4 comes close to power transmission coil 3.

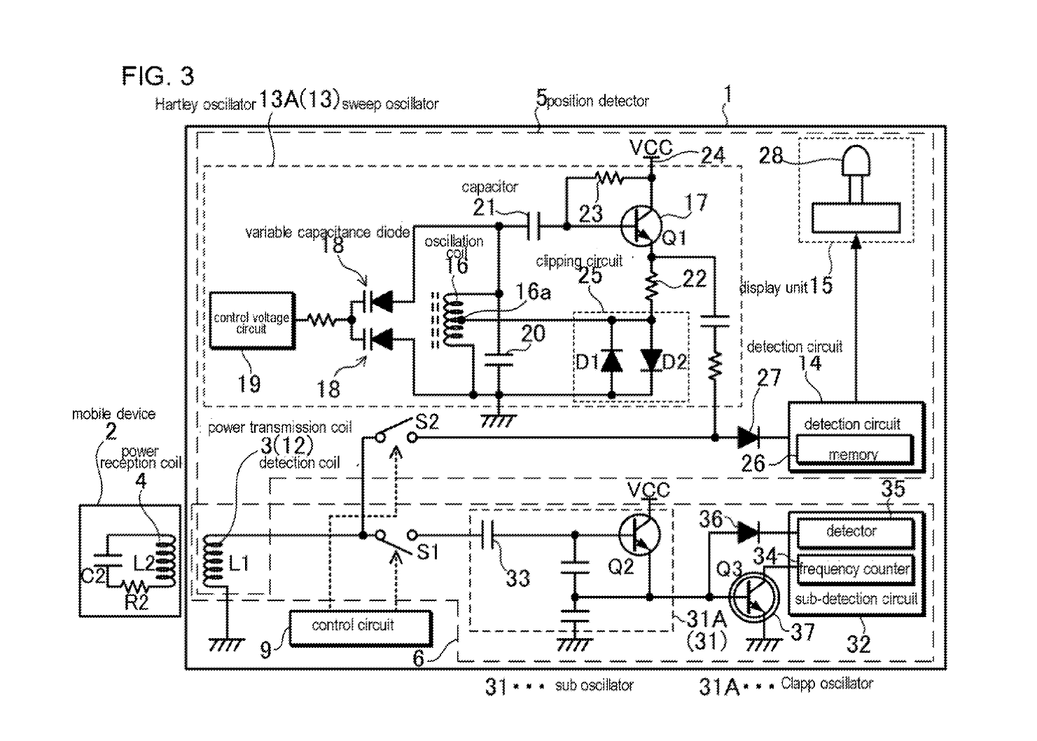

Position detector 5 in FIG. 3 includes detection coil 12 that detects the position of power reception coil 4, sweep oscillator 13 that supplies an AC signal having a changing frequency to detection coil 12, detection circuit 14 that detects a change in impedance of detection coil 12 with respect to the frequency of the AC signal supplied from sweep oscillator 13 to detection coil 12, and display unit 15 that detects the position of power reception coil 4 relative to detection coil 12 from the change in impedance with respect to the frequency and displays the detected position.

Position detector 5 detects the change in impedance with respect to the frequency of the AC signal supplied to detection coil 12 using detection circuit 14, and detects the position of power reception coil 4 relative to power transmission coil 3, and displays the detected position using display unit 15.

Detection coil 12 is provided to detect approximation of power reception coil 4. In power source stand 1 illustrated in a circuit diagram of FIG. 3, power transmission coil 3 is also used as detection coil 12. Accordingly, in a state in which the position of power reception coil 4 relative to power transmission coil 3 is detected, switch S2 is turned on, and detection coil 12 is connected to an output side of sweep oscillator 13. At this point, switch S1 is turned off to separate power transmission coil 3 from another circuit (later-described sub oscillator 31).

In power source stand 1, power transmission coil 3 is also used as detection coil 12 without providing dedicated detection coil 12, and the position where power reception coil 4 comes close to power transmission coil 3 can more accurately be detected from the change in impedance with respect to the frequency of power transmission coil 3.

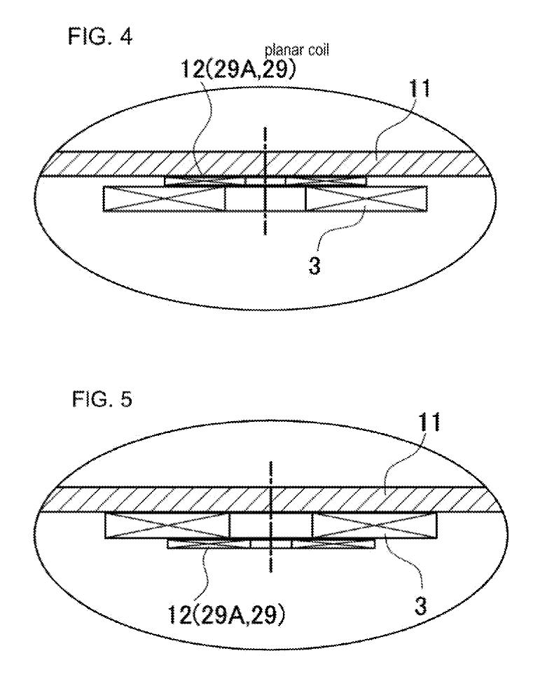

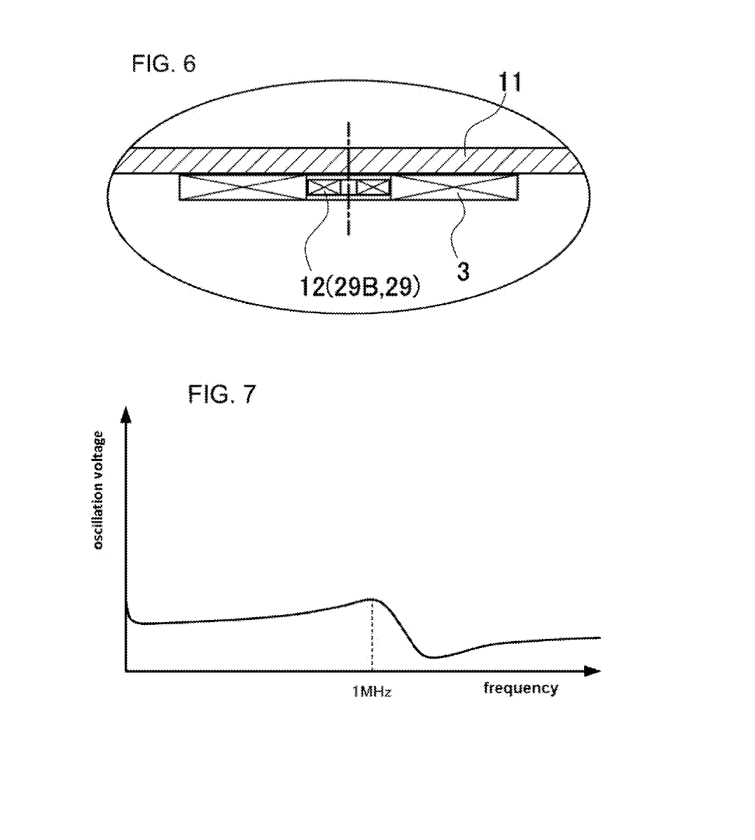

Alternatively, the power source stand may be provided with a dedicated detection coil. In the power source stand of FIGS. 4 to 6, independently of power transmission coil 3, planar coil 29 is fixed to an inner surface of upper plate 11 in concentric with power transmission coil 3, and is used as detection coil 12. Because an amount of the current that flows dedicated detection coil 12 is extremely small, for example, dedicated detection coil 12 can be formed of planar coil 29 made of a thin wire having a diameter of about 0.1 mm. FIG. 4 illustrates an example in which planar coil 29A that is detection coil 12 is disposed between power transmission coil 3 and upper plate 11. In planar coil 29 made of the thin wire, detection coil 12 can be provided without widening a distance between power reception coil 4 and power transmission coil 3. Further, FIG. 5 illustrates a state in which planar coil 29A is laminated on a surface of power transmission coil 3. Planar coil 29A illustrated in FIG. 5 is laminated on and fixed to the surface of power transmission coil 3, namely, the surface on the opposite side to upper plate 11. In the structure of FIG. 5, planar coil 29A can concentrically disposed with power transmission coil 3 while power transmission coil 3 is brought close to the inner surface of upper plate 11 to minimize the distance between power reception coil 4 and power transmission coil 3. Furthermore, in FIG. 6, planar coil 29B is disposed in a hollow portion in a center of power transmission coil 3. In the structure of FIG. 6, the distance between power transmission coil 3 and detection coil 12 and power reception coil 4 can be minimized while dedicated detection coil 12 is disposed at a given position of power transmission coil 3 in a space-saving manner.

Sweep oscillator 13 changes the frequency at a predetermined oscillation frequency. This sweep oscillator includes oscillation coil 16, transistor 17 that is connected to oscillation coil 16, variable capacitance diode 18 that is connected to oscillation coil 16, and control voltage circuit 19 that supplies a periodically changing control voltage to variable capacitance diode 18.

In sweep oscillator 13 of FIG. 3, a series circuit of capacitor 20 and a pair of variable capacitance diodes 18 and 18 is connected in parallel to oscillation coil 16 in a form of Hartley oscillator 13A. In Hartley oscillator 13A of FIG. 3, one end of oscillation coil 16 is connected to a base of transistor 17 through capacitor 21, and intermediate terminal 16a of oscillation coil 16 is connected to an emitter of transistor 17 through load resistor 22. In transistor 17, a collector is connected to power line 24, the base is connected to power line 24 through bias resistor 23, and the AC signal is output from the emitter.

Meanwhile, an electronic oscillator in which an oscillation frequency is controlled by variable capacitance diode 18 has a characteristic of changing the oscillation voltage according to the oscillation frequency. This is because a Q value of variable capacitance diode 18 decreases with increasing electrostatic capacitance. The oscillation voltage decreases with decreasing Q value of variable capacitance diode 18. Therefore, in the electronic oscillator in which the oscillation frequency is adjusted by changing the electrostatic capacitance of variable capacitance diode 18, the oscillation voltage decreases when the oscillation frequency decreases with increasing electrostatic capacitance of variable capacitance diode 18. In position detector 5 of FIG. 3, the change in impedance of power transmission coil 3 that is detection coil 12 with respect to the frequency is detected based on a change in voltage at both ends of detection coil 12 to detect the position of power reception coil 4. Therefore, the position of power reception coil 4 cannot accurately be detected when the oscillation voltage at the electronic oscillator is changed by the frequency. This is because whether the change in voltage at detection coil 12 is caused by the electronic oscillator or the position of power reception coil 4 cannot be determined.

In sweep oscillator 13 of FIG. 3, clipping circuit 25 is connected in parallel to oscillation coil 16 in order to stabilize the oscillation voltage at a constant amplitude. Clipping circuit 25 is a diode clipping circuit in which a pair of diodes D1 and D2 is connected in reverse parallel to each other. Clipping circuit 25 is connected to a part of oscillation coil 16, namely, between intermediate terminal 16a of oscillation coil 16 and a ground side. Clipping circuit 25 restricts the voltage at both ends to about 0.6 V to stabilize the oscillation voltage, namely, an output level from the emitter of transistor 17 at a constant amplitude. A voltage waveform of both the ends of clipping circuit 25 becomes a rectangular wave because clipping circuit 25 restricts the amplitude. On the other hand, the voltage at both the ends of oscillation coil 16 becomes a sine wave by an electronic oscillator of oscillation coil 16 and capacitor 20, and is output as the sinusoidal AC signal from the emitter of transistor 17.

Sweep oscillator 13 in FIG. 3 identifies the oscillation frequency from inductance of oscillation coil 16 and electrostatic capacitances of capacitor 20 and variable capacitance diode 18. Thus, the electrostatic capacitance of variable capacitance diode 18 is controlled by the control voltage input from control voltage circuit 19, and the oscillation frequency changes as illustrated in FIG. 7. Control voltage circuit 19 inputs the control voltage having a saw-tooth wave to change the electrostatic capacitance of variable capacitance diode 18 at a constant period, and changes the oscillation frequency of sweep oscillator 13 at a predetermined period as illustrated in FIG. 7.

Detection circuit 14 detects the position of power reception coil 4 relative to detection coil 12 by detecting the change in impedance of detection coil 12 with respect to the frequency of the AC signal supplied from sweep oscillator 13 to detection coil 3 that is detection coil 12.

In the state in which the position of power reception coil 4 relative to power transmission coil 3 is detected, power source stand 1 illustrated in the circuit diagram of FIG. 3 turns off switch S1 to separate power transmission coil 3 from another circuit (sub oscillator 31), and turns on switch S2 to connect power transmission coil 3 used in detection coil 12 to the output side of sweep oscillator 13.

In an equivalent circuit to which power reception coil 4 is coming close, power reception coil 4 is connected to power transmission coil 3 that is also used as detection coil 12 with coupling coefficient M, and impedance Z changes. Because detection coil 12 is connected as a load of sweep oscillator 13, the impedance of detection coil 12 becomes load impedance Z of sweep oscillator 13.

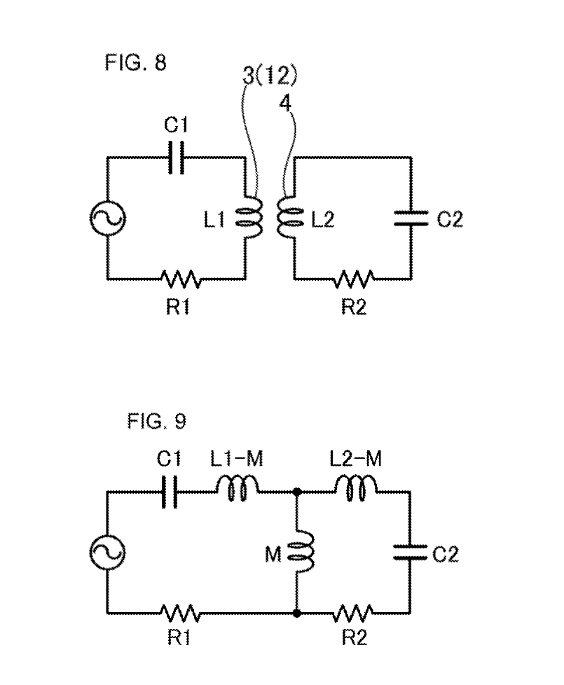

FIG. 8 illustrates a state in which power reception coil 4 is coupled to power transmission coil 3, and FIG. 9 illustrates an equivalent circuit of the state in FIG. 8. Referring to FIGS. 8 and 9,

assuming that L1 is inductance of power transmission coil 3,

C1 is of an electrostatic capacitance of a coupling capacitor,

R1 is an electric resistance of a series resistor,

L2 is inductance of power reception coil 4,

C2 is an electrostatic capacitance of a capacitor connected in parallel to power reception coil 4,

R2 is an electric resistance of a resistance component connected to the power reception coil 4 side,

M is a coupling coefficient of both the coils, and

Z1 is impedance on the power transmission coil 3 side while Z2 is impedance on the power reception coil 4 side, the following equations are obtained.

$$\begin{matrix}Z 1 = R 1 + j ω L 1 - j ω M - j \frac{1}{ω C 1} & [ Mathematical formula 1 ] \\ Z 2 = R 2 + j ω L 2 - j ω M - j \frac{1}{ω C 2} & [ Mathematical formula 2 ]\end{matrix}$$

Assuming that Z3 is a receiving-side impedance including coupling coefficient M, the following equation is obtained.

$$Z 3 = \frac{j ω M * Z 2}{j ω M + Z 2} = j ω M + \frac{{( ω M )}^{2}}{R 2 + j ω L 2 - j \frac{1}{ω C 2}} \qquad [ Mathematical formula 3 ]$$

The impedance of the whole circuit, namely, load impedance Z of Hartley oscillator 13A is obtained as follows.

$$[ Mathematical formula 4 ]$$

$$\begin{matrix}Z = Z 1 + Z 3 = j ω L 1 - j \frac{1}{ω C 1} + R 1 + \frac{{( ω M )}^{2}}{j ω L 2 - j \frac{1}{ω C 2} + R 2} \\ = R 1 + j ( ω L 1 - \frac{1}{ω C 1} ) + ( \frac{{( ω M )}^{2}}{R 2 + j ( ω L 2 - \frac{1}{ω C 2} )} ) \\ = R 1 + j ( ω L 1 - \frac{1}{ω C 1} ) + ( \frac{{( ω M )}^{2} * ( R 2 - j ( ω L 2 - \frac{1}{ω C 2} ) )}{R {2}^{2} + {( ω L 2 - \frac{1}{ω C 2} )}^{2}} ) \\ = R 1 + j ( ω L 1 - \frac{1}{ω C 1} ) + \frac{{( ω M )}^{2} * R 2}{R {2}^{2} + {( ω L 2 - \frac{1}{ω C 2} )}^{2}} - \\ j \frac{{( ω M )}^{2} * ( ω L 2 - \frac{1}{ω C 2} )}{R {2}^{2} + {( ω L 2 - \frac{1}{ω C 2} )}^{2}} \\ = R 1 + \frac{{( ω M )}^{2} * R 2}{R {2}^{2} + {( ω L 2 - \frac{1}{ω C 2} )}^{2}} + \\ j ( ω L 1 - \frac{1}{ω C 1} - \frac{{( ω M )}^{2} * ( ω L 2 - \frac{1}{ω C 2} )}{R {2}^{2} + {( ω L 2 - \frac{1}{ω C 2} )}^{2}} )\end{matrix}$$

For example, it is assumed that a resonant frequency identified by inductance L2 of power reception coil 4 and electrostatic capacitance C2 of the capacitor is about 1 MHz, and that sweep oscillator 13 changes the frequency in a range of 750 kHz to 1.5 MHz. At this point, there are portions in which load impedance Z becomes maximum and minimum at a frequency slightly higher than a resonant frequency of 1 MHz of power reception coil 4, and a difference between a maximum value and a minimum value, namely, a value of change in impedance (ΔZ) with respect to the frequency changes according to the position of power reception coil 4 relative to power transmission coil 3.

The value of change in impedance (ΔZ) with respect to the frequency increases when power reception coil 4 comes close to power transmission coil 3, and the value of change in impedance (ΔZ) with respect to the frequency decreases when power reception coil 4 separates from power transmission coil 3. This is because the value of change in impedance (ΔZ) changes by coupling coefficient M of power reception coil 4 and power transmission coil 3. Coupling coefficient M increases as power reception coil 4 comes close to power transmission coil 3. Therefore, the value of change in impedance (ΔZ) with respect to the frequency increases when power reception coil 4 comes close to power transmission coil 3 to increase coupling coefficient M, and the value of change in impedance (ΔZ) with respect to the frequency decreases when power reception coil 4 separates from power transmission coil 3. Detection circuit 14 detects the position of power reception coil 4 relative to power transmission coil 3, namely, the approximation of power reception coil 4 to power transmission coil 3 from the value of change in impedance (ΔZ) with respect to the frequency.

Detection circuit 14 in FIG. 3 detects the change in load impedance Z from the change in oscillation voltage. This is because the oscillation voltage, namely, the output voltage of sweep oscillator 13 decreases when load impedance Z decreases. Detection circuit 14 in FIG. 3 rectifies the AC signal output from sweep oscillator 13 using diode 27, and detects the output voltage at a DC level. Detection circuit 14 compares the DC level output from sweep oscillator 13 to a setting value, and determines whether the value of change in impedance (ΔZ) is larger than the setting value. That is, when the value of change in impedance (ΔZ) is larger than the setting value, the value of change in DC level (ΔV) is lower than the setting value. In other words, detection circuit 14 compares the value of change in DC level (ΔV) with respect to the frequency to the setting value stored in memory 26, and determines whether the value of change in impedance (ΔZ) with respect to the frequency is larger than the setting value. That is, detection circuit 14 compares the value of change (ΔV) to the setting value previously stored in memory 26, determines that power reception coil 4 is located at the position close to power transmission coil 3 when the value of change (ΔV) is larger than the setting value of memory 26, and determines that power reception coil 4 is not located at the position close to power transmission coil 3 when the value of change (ΔV) is smaller than the setting value.

Detection circuit 14 in FIG. 3 detects the value of change in oscillation voltage (ΔV) of sweep oscillator 13 at the DC level, and compares the value of change (ΔV) to the setting value, so that whether the value of change (ΔV) is larger than the setting value can be determined by the simple circuit configuration. Detection circuit can also compare the value of change in oscillation voltage (ΔV) of sweep oscillator 13 to the setting value at an AC level.

Detection circuit 14 can compare the value of change in output voltage (ΔV) to a plurality of setting values previously stored in memory 26, and determine whether power reception coil 4 is located at the position close to power transmission coil 3 as a plurality of steps such as a closest position, a close position, and a non-close position. Detection circuit 14 that determines the position of power reception coil 4 at three stages of the closest position, the close position, and the non-close position stores a first setting value used to determine the closest position and a second setting value used to determine the close position in memory 26. Detection circuit 14 makes a determination of the closest position when determining that the value of change in output voltage (ΔV) with respect to the frequency is greater than or equal to the first setting value, detection circuit 14 makes a determination of the close position when determining that the value of change in output voltage (ΔV) is less than the first setting value and greater than or equal to the second setting value, and detection circuit 14 makes a determination of the non-close position when determining that the value of change in output voltage (ΔV) is less than the second setting value. Detection circuit 14 may store more setting values, compare the value of change in output voltage (ΔV) to the stored setting values, and more finely determine the position of power reception coil 4.

In detection circuit 14, the value of change in impedance (ΔZ) is detected by the oscillation voltage of sweep oscillator 13, so that the value of change in impedance (ΔZ) can be detected by the simple circuit configuration. Alternatively, the detection circuit may detect the position of the power reception coil relative to the power transmission coil by detecting the impedance of the sweep oscillator or by detecting the value of change in impedance (ΔZ) from detection of the load current.

Detection circuit 14 detects the position of power reception coil 4 relative to power transmission coil 3 by detecting the value of change with respect to the frequency from the difference between maximum value and the minimum value. In detection circuit 14, the value of change in impedance or voltage increases, so that the position of power reception coil 4 relative to power transmission coil 3 can more accurately be detected. The detection circuit does not necessarily detect the position of the power reception coil relative to the power transmission coil by detecting the value of change in impedance or the change in output voltage from the difference between the maximum value and the minimum value, but the detection circuit can detect the position of the power reception coil relative to the power transmission coil by detecting the value of change in impedance or the change in voltage from the maximum value and the minimum value. This is because, as the power reception coil comes close to the power transmission coil, the maximum value of the impedance or output voltage increases while the minimum value decreases.

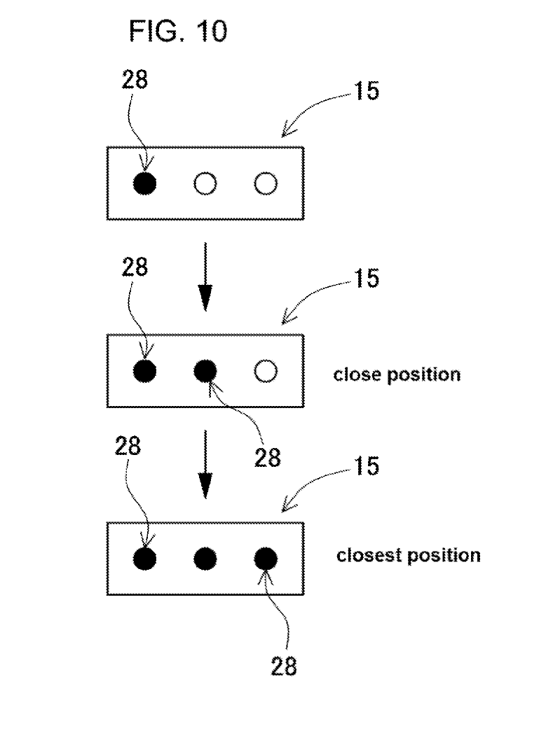

Display unit 15 displays the position of power reception coil 4 detected by detection circuit 14. Display unit 15 displays the position of power reception coil 4 relative to power transmission coil 3 by turning on a pilot lamp such as LED 28. Display unit 15 displays the close position of power reception coil 4 by an emission color of LED 28. For example, display unit 15 is turned on in red when mobile device 2 is set in power source stand 1 to dispose power reception coil 4 in the close position, and display unit 15 is turned on in blue to display the position of power reception coil 4 when power reception coil 4 is not located at the close position. In display unit 15, LED 28 is not turned on unless mobile device 2 is set in power source stand 1. Display unit 15 that displays the position of power reception coil 4 relative to power transmission coil 3 at the three stages of the closest position, the close position, and the non-close position turns on the LED in red, green, and blue for displaying. As illustrated in FIG. 10, display unit 15 can also display the close position by the number of turned-on LEDs 28. In the display unit 15 of FIG. 10, all LEDs 28 are turned on when mobile device 2 is set in power source stand 1 and power reception coil 4 comes close to power transmission coil 3, and the number of turned-on LEDs 28 decreases as power reception coil 4 separates from power transmission coil 3. Although not illustrated, the display unit can display the position of the power reception coil relative to the power transmission coil using an analog meter or a digital meter. The display unit displays a relative distance between the power reception coil and the power transmission coil using the analog meter or the digital meter. In the meter of the display unit, the position where a pointer scores maximally is set to the position where the power reception coil comes closest to the power transmission coil. In the present invention, the display unit is not specifically designed for the above structures, but any structure displaying the state in which the power reception coil comes close to the power transmission coil may be applied.

Power source stand 1 starts the detection of the position of power reception coil 4 after a start-up circuit detects the setting of mobile device 2. In the power source stand, a switch (not illustrated) operated by a user is provided as a start-up circuit, and the setting of the mobile device is detected by on and off signals of the switch, which allows the position detection of the power reception coil to be started. Alternatively, in the power source stand, the user does not operate the switch or the like, but the position detection of the power reception coil may be started by automatically detecting the setting of the mobile device. The power source stand can conveniently be used because the user does not operate the switch or the like, but the position detection is started when the mobile device is set.

Power source stand 1 includes start-up circuit 6 that detects the setting of mobile device 2 by the change in inductance of detection coil 12. Detection coil 12 can also be used as power transmission coil 3. However, the power source stand of the present invention does not specify the circuit configuration that detects the setting of the mobile device. For example, the detection position of the power reception coil can also be started by putting the position detector into the operating state at a constant period.

A specific example of start-up circuit 6 that detects that mobile device 2 is set in power source stand 1 while power transmission coil 3 is also used as detection coil 12 will be described below. The inductance of power transmission coil 3 increases when mobile device 2 is set. This is because a magnetic material such as magnetic shield 44 incorporated in mobile device 2 comes close to detection coil 12 to increase magnetic flux density. Power source stand 1 in FIGS. 2 and 3 includes start-up circuit 6 that detects the setting of mobile device 2 by the increase in inductance of power transmission coil 3. Start-up circuit 6 includes sub oscillator 31 and sub-detection circuit 32. Sub oscillator 31 identifies the oscillation frequency by the inductance of power transmission coil 3. Sub-detection circuit 32 detects the setting of mobile device 2 by detecting the change in inductance from the change in oscillation frequency of sub oscillator 31, or sub-detection circuit 32 detects the setting of mobile device 2 by detecting the change in oscillation voltage of sub oscillator 31.

While start-up circuit 6 detects the setting of mobile device 2, control circuit 9 turns off switch S2, and turn on switch S1, thereby connecting power transmission coil 3 also used as detection coil 12 to sub oscillator 31.

Sub oscillator 31 in FIG. 3 is Clapp oscillator 31A. Sub oscillator 31 identifies the oscillation frequency from the electrostatic capacitance of capacitor 33 connected in series with power transmission coil 3. The oscillation frequency (f) of sub oscillator 31 is identified by the following equation from the inductance (L) of power transmission coil 3 and the electrostatic capacitance (C) of capacitor 33.

$$f = \frac{1}{2 π \sqrt{LC}} \qquad [ Mathematical formula 5 ]$$

Sub-detection circuit 32 detects the oscillation frequency (f) by detecting the oscillation frequency of sub oscillator 31 using frequency counter 34, and calculates the inductance (L) of power transmission coil 3 from the oscillation frequency (f). When the oscillation frequency (f) is detected, the inductance (L) of power transmission coil 3 is calculated from the oscillation frequency (f) and the electrostatic capacitance (C) of capacitor 33 using the following equation.

$$L = \frac{1}{4 {π}^{2} {f}^{2} C} \qquad [ Mathematical formula 6 ]$$

Sub-detection circuit 32 calculates the inductance (L), and detects the setting of mobile device 2 by comparing the calculated inductance (L) to a threshold. Alternatively, the sub-detection circuit does not necessarily calculate the inductance to compare the inductance to the threshold, but the sub-detection circuit may detect the setting of the mobile device from the frequency identified by the inductance. Because the oscillation frequency changes when the inductance changes, the method for comparing the frequency to the threshold to detect the mobile device is substantially equal to the method for comparing the inductance to the threshold to detect the mobile device. The setting of the mobile device can more simply be determined by the method for detecting the mobile device from the oscillation frequency without calculating the inductance.

While mobile device 2 is not set in upper plate 11 of power source stand 1, the inductance of power transmission coil 3 is used as the reference inductance, and sub-detection circuit 32 determines the setting of mobile device 2 from the increasing amount of change in inductance (ΔH) with respect to the reference inductance. While mobile device 2 is not set, sub-detection circuit 32 detects the amount of change in inductance (ΔH) of detection coil 12 at a predetermined period (for example, 1-second period) to determine whether the mobile device 2 is set.

When the mobile device 2 is set in upper plate 11 of power source stand 1, the amount of change in inductance (ΔH) that increases the inductance (L) of power transmission coil 3 changes according to each mobile device 2. This is because a material, a size, and a shape of magnetic shield 44 of power reception coil 4 incorporated in mobile device 2, the distance from power transmission coil 3 to magnetic shield 44, and the like vary. Mobile device 2 is set in upper plate 11 of power source stand 1, the amount of change in inductance (ΔH) of power transmission coil 3 is detected, the detected amount of change in inductance (ΔH) is stored in the memory of each mobile device 2, and the stored information is transmitted from mobile device 2 to power source stand 1. Thus, sub-detection circuit 32 can more accurately determine the setting of mobile device 2. This is attributed to the following reason. While mobile device 2 is set in power source stand 1, a threshold for the amount of change in inductance (ΔH) is transmitted from mobile device 2 to power source stand 1, sub-detection circuit 32 of power source stand 1 can determine the setting of mobile device 2 by comparing the amount of change in inductance (ΔH) to the threshold.

Sub-detection circuit 32 in FIG. 3 includes detector 35 that detects the change in oscillation voltage of sub oscillator 31. Detector 35 in FIG. 3 rectifies the AC signal output from sub oscillator 31 using diode 36, and detects the output voltage at the DC level. In start-up circuit 6 in FIG. 3, diode 36 that rectifies the output to converts the output into the direct current is connected to the base of transistor 37 connected to the output side of sub oscillator 31, and the output side of diode 36 is connected to detector 35 of sub-detection circuit 32. Diode 36 rectifies the AC component that is the output from sub oscillator 31, and outputs the DC voltage corresponding to an amplitude of the AC component. Diode 36 outputs the DC voltage to detector 35. Detector 35 detects the oscillation voltage of sub oscillator 31 at the DC level from the DC voltage input from diode 36.

While mobile device 2 is not set in upper plate 11 of power source stand 1, the oscillation voltage of sub oscillator 31 is used as a reference voltage, and sub-detection circuit 32 determines the setting of mobile device 2 from the amount of change oscillation voltage (ΔV) with respect to the reference voltage. While mobile device 2 is not set, sub-detection circuit 32 detects the amount of change in oscillation voltage (ΔV) of sub oscillator 31 at a predetermined period (for example, 1-second period) to determine whether the mobile device 2 is set.

In power source stand 1, switch S1 is turned on, switch S2 is turned off, start-up circuit 6 detects the setting of mobile device 2. When start-up circuit 6 detects the setting of mobile device 2, switch S1 is turned off, and switch S2 is turned on, position detector 5 detects whether mobile device 2 is set at the optimum position, namely, whether power reception coil 4 is disposed at the position close to power transmission coil 3 so that the power can efficiently be transmitted, and displays the detected information. Position detector 5 displays the position of power reception coil 4 relative to power transmission coil 3 and the user moves mobile device 2 while viewing the display content. Thus, mobile device 2 can be set at the optimum position of power source stand 1 to bring power reception coil 4 close to power transmission coil 3.

When detecting that mobile device 2 is set at the optimum position, position detector 5 controls control circuit 9 such that control circuit 9 turns off switches S1 and S2, power transmission coil 3 is connected to AC power source 8, and the AC power is supplied from AC power source 8 to power transmission coil 3, to start the power transmission.

For example, AC power source 8 supplies a high-frequency power of 20 kHz to 1 MHz to power transmission coil 3. Although not illustrated, AC power source 8 includes an electronic oscillator and a power amplifier that amplifies the AC power output from the electronic oscillator. The AC power of power transmission coil 3 is transmitted to power reception coil 4. Mobile device 2 charges built-in battery 41, or puts the device into an operating state. When battery 41 is fully charged, power source stand 1 that charges battery 41 of mobile device 2 detects a full charging signal transmitted from transmission circuit 43 of mobile device 2 using receiving circuit 7. When power source stand 1 detects the full charging signal, control circuit 9 controls AC power source 8 to stop the power supplied to power transmission coil 3, thereby stopping the charging of battery 41.

As described above, detection circuit 14 detects the position of power reception coil 4 relative to power transmission coil 3 by detecting the value of change with respect to the frequency from the difference between maximum value and the minimum value. As the power reception coil comes close to the power transmission coil, the impedance of detection coil 12 or the maximum value of the output voltage increases, and the minimum value decreases. When the difference between the maximum value and the minimum value is maximized, power reception coil 4 comes closest to power transmission coil 3, namely, the centers of the planar coils having the circular shape (or substantially circular shape) are matched with each other.

In the exemplary embodiment, as illustrated in FIG. 7, the maximum value and minimum value of the output voltage from detection coil 12 can detect the maximum value at a frequency around 1 MHz, and detect the minimum value at a higher frequency adjacent to the maximum value. Detection circuit 14 can detect the difference between the maximum value and the minimum value in a positional relationship (a positional relationship between the power reception coil and the power transmission coil) at that time.

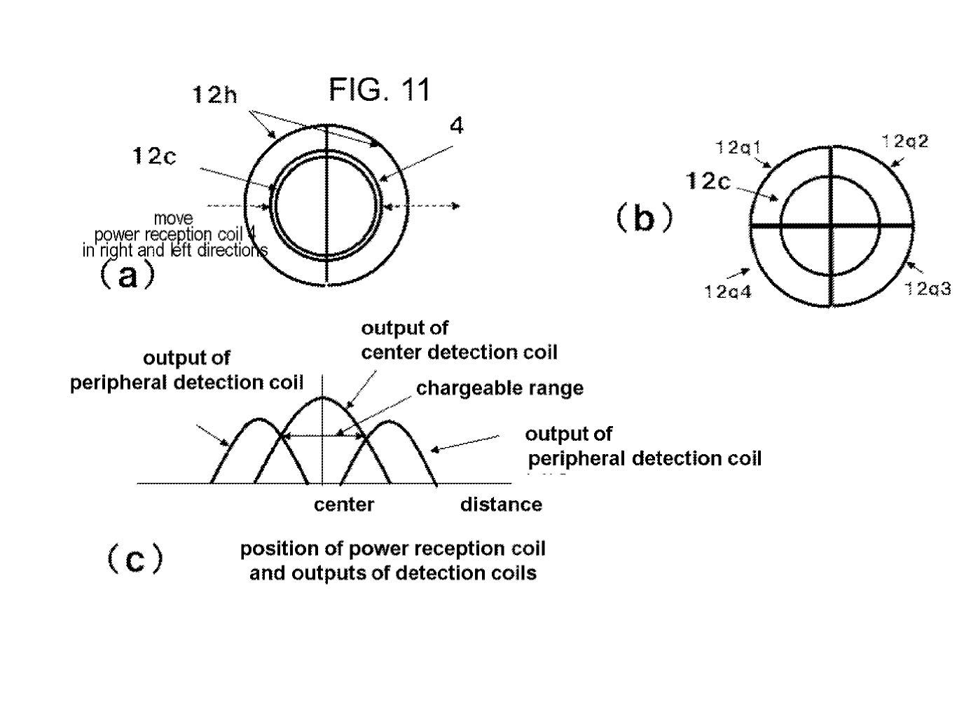

As illustrated in FIGS. 11(a) and 11(b), the power reception coil includes a center detection coil that is concentric with power transmission coil (3) and a plurality of peripheral detection coils each of which is disposed around the center detection coil, and the peripheral detection coils are disposed at equal intervals in an outer peripheral portion around a center of the center detection coil.

In FIG. 11(a), semicircular planar peripheral detection coils 12h and 12h are disposed around center detection coil 12c. In FIG. 11(b), four fan-like (center angle of 90 degrees) planar peripheral detection coils 12q1, 12q2, 12q3, and 12q4 are disposed around center detection coil 12c.

In FIG. 11(c), a horizontal axis indicates the distance from the center of the center detection coil, and a vertical axis indicates the difference between the maximum value and the minimum value of the output voltage from each detection coil 12 in the positional relationship of the coil arrangement in FIGS. 11(a) and 11(b) when the power reception coil comes close to the position (=position of power transmission coil) of center detection coil 12c from a horizontal direction of a paper plane in FIG. 11 (from a dotted-line arrow direction in FIG. 11(a)). Although not illustrated, the center detection coil and the peripheral detection coil are separated from each other, a switch corresponding to switch S2 is selectively connected to the detection coil, and the center detection coil and the peripheral detection coil are detected by detection circuit 14. In FIG. 11(b), the outputs of peripheral detection coils 12q1 and 12q4 are equal to the outputs of peripheral detection coils 12q2 and 12q3 because the power reception coil comes close to the detection coils from the horizontal direction of the paper plane. As the power reception coil comes close to the center of the center detection coil (power transmission coil) from an outer periphery, the value of the peripheral detection coil increases, reaches a peak, and then decreases. The value of the center detection coil increases toward the center, and becomes a peak in the center.

As illustrated in FIG. 11(c), in the exemplary embodiment, when the user moves mobile device 2 to bring the power reception coil close to the center of the center detection coil (power transmission coil) from the outer periphery, LED 28 of display unit 15 is turned on in a specific color (for example, red) at time the value of the peripheral detection coil is larger than a predetermined value. Therefore, the user can understand that mobile device 2 comes close to the center. Then, when the power reception coil is brought closer to the center detection coil (power transmission coil), the value of the center detection coil becomes larger than the value of the peripheral detection coil. At this point, LED 28 of display unit 15 is turned on in another color (for example, blue) as a chargeable range. Therefore, the user can understand that mobile device 2 is located at the chargeable position (close position).

As the center of the power reception coil is further brought close to the center of the center detection coil (power transmission coil), the emission intensity (emission luminance or emission illuminance) is increased in turning on LED 28 (for example, in blue) of display unit 15. The emission intensity (emission luminance or emission illuminance) corresponds to the value of the center detection coil in FIG. 11(c), so that the user can understand that mobile device 2 comes close to the center.

The user searches the position having the maximum emission intensity (emission luminance or emission illuminance) while slightly moving mobile device 2, and the user places mobile device 2 at the position having the maximum emission intensity to start the charging at the optimum position.

In FIGS. 11(a) and 11(b), the planar coil illustrated in FIG. 4 or the like is used although the coil is indicated by a line. The coil may be a coil that is patterned on a printed board. For example, the center detection coil may be patterned on the top surface side (the side of upper plate 11) of the printed board while the peripheral detection coil is patterned on the bottom surface side of the printed board. The printed board is disposed on the power transmission coil.

### INDUSTRIAL APPLICABILITY

The present invention is suitably applied to the power source stand, in which the power transmission coil is fixed, and the power can efficiently be transmitted from the power transmission coil to the power reception coil.

### REFERENCE MARKS IN THE DRAWINGS

1 power source stand
2 mobile device
3 power transmission coil
4 power reception coil
5 position detector
6 start-up circuit
7 receiving circuit
8 AC power source
9 control circuit
10 case
11 upper plate
12 detection coil
12c center detection coil
12q1 to 12q4 peripheral detection coil
13 sweep oscillator
13A Hartley oscillator
14 detection circuit
15 display unit
16 oscillation coil
16a intermediate terminal
17 transistor
18 variable capacitance diode
19 control voltage circuit
20 capacitor
21 capacitor
22 load resistor
23 bias resistor
24 power line
25 clipping circuit
26 memory
27 diode
28 LED
29 planar coil
29A planar coil
29B planar coil
31 sub oscillator
31A Clapp oscillator
32 sub-detection circuit
33 capacitor
34 frequency counter
35 detector
36 diode
37 transistor
41 battery
42 charging control circuit
43 transmission circuit
44 magnetic shield
S1 switch
S2 switch
D1 diode
D2 diode

1-17. (canceled)

18. A power source stand to which a power transmission coil is fixed, the power source stand comprising:
a position detector that detects a relative position between a power reception coil of a mobile device to be set in the power source stand and the power transmission coil incorporated in the power source stand, and displays the detected relative position,
wherein the position detector includes:
a detection coil that detects a position of the power reception coil;
a sweep oscillator that supplies an AC signal having a changing frequency to the detection coil;
a detection circuit that detects a change in impedance of the detection coil with respect to the frequency of the AC signal supplied from the sweep oscillator to the detection coil; and
a display unit that detects the position of the power reception coil from the change in impedance and displays the detected position of the power reception coil,
the position detector detects the position of the power reception coil from the change in impedance of the detection coil which is detected using the detection circuit, and the display unit) displays the position of the power reception coil,
wherein the detection circuit detects the position of the power reception coil at a value of change in impedance (ΔZ) which is a difference between a maximum value and a minimum value of the impedance of the detection coil,
wherein the detection circuit detects the position of the power reception coil by a difference between a maximum value and a minimum value in a change in oscillation voltage of the detection coil,
the detection coil includes a plurality of coils,
the plurality of coils include:
a center detection coil concentric with the power transmission coil; and
a peripheral detection coil disposed around the center detection coil, and
the position where the power reception coil is brought close to is displayed when the difference between the maximum value and the minimum value in the change in oscillation voltage of the center detection coil is larger than the difference between the maximum value and the minimum value in the change in oscillation voltage of the peripheral detection coil.

19. The power source stand according to claim 18, wherein the sweep oscillator changes the frequency in a range of 750 kHz to 1.5 MHz.

20. The power source stand according to claim 18, wherein the power transmission coil is also used as the detection coil.

21. The power source stand according to claim 18, wherein the detection coil is a planar coil that is disposed concentric with the power transmission coil.

22. The power source stand according to claim 18, wherein the detection circuit detects the change in impedance of the detection coil by a change in oscillation voltage of the sweep oscillator.

23. The power source stand according to claim 18, wherein the detection circuit converts the oscillation voltage of the sweep oscillator into a direct current, and detects the change in impedance of the detection coil at a DC level.

24. The power source stand according to claim 18, wherein the detection circuit detects the position of the power reception coil at a minimum value of the impedance of the detection coil.

25. A power source stand to which a power transmission coil is fixed, the power source stand comprising:
a position detector that detects a relative position between a power reception coil of a mobile device to be set in the power source stand and the power transmission coil incorporated in the power source stand, and displays the detected relative position,
wherein the position detector includes:
a detection coil that detects a position of the power reception coil;
a sweep oscillator that supplies an AC signal having a changing frequency to the detection coil;
a detection circuit that detects a change in impedance of the detection coil with respect to the frequency of the AC signal supplied from the sweep oscillator to the detection coil; and
a display unit that detects the position of the power reception coil from the change in impedance and displays the detected position of the power reception coil,
the position detector detects the position of the power reception coil from the change in impedance of the detection coil which is detected using the detection circuit, and the display unit displays the position of the power reception coil,
wherein the sweep oscillator includes:
an oscillation coil;
a variable capacitance diode that is connected to the oscillation coil; and
a control voltage circuit that supplies a control voltage changing at a constant period to the variable capacitance diode, and
the sweep oscillator is a Hartley oscillator in which the control voltage is input from the control voltage circuit to the variable capacitance diode to change an oscillation frequency at a constant period.

26. The power source stand according to claim 25, wherein a diode clipping circuit, in which a pair of diodes are connected in reverse parallel to each other, is connected in parallel to a part of the oscillation coil.

27. The power source stand according to claim 26, wherein
the oscillation coil includes an intermediate terminal, and
the diode clipping circuit is connected in parallel between the intermediate terminal and one end of the oscillation coil.

28. The power source stand according to claim 27, wherein
one end of the oscillation coil is connected to a base of a transistor constituting the Hartley oscillator through a capacitor,
the intermediate terminal of the oscillation coil is connected to an emitter of the transistor, and
the diode clipping circuit is connected between the emitter of the transistor and a ground.

29. A power source stand to which a power transmission coil is fixed, the power source stand comprising:
a position detector that detects a relative position between a power reception coil of a mobile device to be set in the power source stand and the power transmission coil incorporated in the power source stand, and displays the detected relative position,
wherein the position detector includes:
a detection coil that detects a position of the power reception coil;
a sweep oscillator that supplies an AC signal having a changing frequency to the detection coil;
a detection circuit that detects a change in impedance of the detection coil with respect to the frequency of the AC signal supplied from the sweep oscillator to the detection coil; and
a display unit that detects the position of the power reception coil from the change in impedance and displays the detected position of the power reception coil,
the position detector detects the position of the power reception coil from the change in impedance of the detection coil which is detected using the detection circuit, and the display unit displays the position of the power reception coil,
further comprising:
a sub oscillator that detects that the mobile device is set; and
a sub-detection circuit that detects that the mobile device is set by detecting a change in inductance of the power transmission coil due to a change in oscillation frequency of the sub oscillator, or by detecting a change in oscillation voltage of the sub oscillator,
wherein the sub-detection circuit detects that the mobile device is set, and the position detector detects the position of the power reception coil.

30. The power source stand according to claim 29, wherein the sub oscillator is a Clapp oscillator that identifies the oscillation frequency by the inductance of the detection coil.

31. The power source stand according to claim 18, wherein
the peripheral detection coil is formed of a plurality of peripheral detection coils, and
the peripheral detection coils are disposed at equal intervals in an outer peripheral portion around a center of the center detection coil.
